(19) United States
(12) Patent Application Publication
(10) Pub. No.: US 2011/0279670 A1
(43) Pub. Date: Nov. 17, 2011

(54) Apparatus for Measuring Three-Dimensional Profile Using LCD

(75) Inventors: Heui-Jae Park, Seoul (KR); Il-Hwan Lee, Seoul (KR); Soon-Min Choi, Gyeonggi-do (KR); Jeong-Ho Lee, Seoul (KR)

(73) Assignee: SNU PRECISION CO., LTD., Seoul (KR)

(21) Appl. No.: 12/674,173

(22) PCT Filed: Aug. 11, 2008
(86) PCT No.: PCT/KR2008/004652

§ 371 Date: Feb. 19, 2010

(30) Foreign Application Priority Data
Aug. 31, 2007 (KR) 10 2007 0088461

(51) Int. Cl. H04N 7/18

(52) U.S. Cl. 348/136; 348/E07.085

(57) ABSTRACT

Provided is an apparatus for measuring a three-dimensional profile using a LCD in which a sine wave pattern is formed on a measurement object, whereby image information of the measurement object is obtained using the sine wave pattern and a camera, and the image information is analyzed to measure a profile of the measurement object, the apparatus including a LCD projector including: a light source irradiating light forward; a LCD panel disposed at a front side of the light source, generating a sine wave pattern having a plurality of phases and a plurality of periods; polarization plates respectively disposed on front and rear sides of the LCD panel; a first focusing lens disposed apart from a front side of the LCD panel, focusing the sine wave pattern generated by the LCD panel on the measurement object; and a housing supporting the light source, the LCD panel, the polarization plates and the first focusing lens.

### TECHNICAL FIELD

The present invention relates to an apparatus for measuring a three-dimensional profile using a LCD, and more particularly, to an apparatus for measuring a three-dimensional profile using a LCD in which a sine wave pattern is formed on a measurement object, whereby image information of the measurement object is obtained using the sine wave pattern and a camera, and the image information is analyzed to measure a profile of the measurement object.

### BACKGROUND ART

In general, apparatuses for measuring a three-dimensional profile by using a Moire interference pattern are apparatuses in which a lattice pattern generated by irradiating uniformly-shaped light beams on a surface of a measurement object to be examined and a standard lattice pattern overlap with each other, thereby forming a Moire interference pattern, and this interference pattern is measured and interpreted to obtain information on the surface height of the measurement object. By using such measurement method, the three-dimensional profile of the measurement object can be simply and rapidly obtained, and thus is widely used in medical and industrial fields.

The above-described method of measuring a three-dimensional profile by using a Moire interference pattern can be classified as a projection-type method or a shadow-type method. The shadow-type method is a method whereby instead of using a lens, a Moire pattern produced from a shadow of a lattice pattern, generated on a surface of a measurement object is used to measure a profile of the surface of the measurement object. The projection-type method is a method whereby a Moire pattern produced from an image of a lattice, projected on a measurement object by using a lens is used to measure a profile of the surface of the measurement object.

FIG. 1 is a schematic view of a conventional shadow-type measurement apparatus. Referring to FIG. 1, in the shadow-type measurement apparatus, light emitted from a light source 100 passes through a lattice 103, thereby forming a shadow in the form of a lattice on a surface of a measurement object P or forming an image in the form of a lattice by the Talbot effect. The lattice 103 used herein changes the intensity of transmitted light. A shadow image of the lattice 103 and a pattern of the lattice 103 itself are synthesized to form a Moire pattern, and the formed Moire pattern is referred to as a shadow-type Moire pattern. The shadow-type Moire pattern is measured by arranging a two-dimensional image sensor, and in this regard, a plurality of phase-shifted Moire patterns are needed in order to calculate a phase of the shadow-type Moire pattern.

To obtain the phase-shifted Moire patterns, the lattice 103 is moved by a driving means D in a direction towards the measurement object P or in a direction away from the measurement object P. If so, the phase of an interference pattern is varied according to the movement of the lattice 103, and thus at least three phase-shifted Moire patterns can be obtained. The phase-shifted Moire pattern formed by moving the lattice 103 is focused on an image sensor 110 by a focusing lens 109. Measurement of the image of the phase-shifted Moire pattern by using the image sensor 110 and the movement of the lattice 103 are sequentially repeated. By using the plurality of the obtained phase-shifted Moire patterns, information on a three-dimensional profile of an object can he obtained through a known interpretation method.

Such shadow-type measurement device can be simply installed. However, since a shadow of a lattice is used, this device can be applied to only the case when a lattice pattern can be close enough to the measurement object. Therefore, a projection-type measurement apparatus, which overcomes the problems of the shadow-type measurement apparatus, is preferred.

FIG. 2 is a schematic view of a conventional projection-type measurement apparatus. Referring to FIG. 2, in the projection-type measurement apparatus, an image formed while light irradiated from a light source 111 passes through a first lattice 112 is focused on a measurement object P by a first focusing lens 113, and the image of the measurement object P is focused on a second lattice 115 by a second focusing lens 114. The image focused on the second lattice 115 and the image of the second lattice 115 itself are focused on an image sensor 117 by a third focusing lens 116 to obtain a Moire pattern.

In the projection-type measurement apparatus, the first lattice 112 and the second lattice 115 are moved upwards and downwards by a driving means D, thereby obtaining a phase-shifted Moire pattern. The obtained phase-shifted Moire pattern is interpreted using a known interpretation method, thereby obtaining information on a three-dimensional profile of the measurement object. However, the projection-type measurement apparatus requires an expensive precision optical system in order to focus the lattice pattern focused on the measurement object P on the second lattice 115, thereby forming a Moire pattern and to focus the Moire pattern on the image sensor 117. Thus, there is a need for a simplified system that does not need the second focusing lens 114 and the second lattice 115.

To further simplify the projection-type measurement apparatus, a structuralized pattern projection-type apparatus for measuring a profile by projecting a structuralized-type pattern on a measurement object has been proposed.

FIG. 3 is a schematic view of a conventional projection-type measurement apparatus to which a method of projecting a structuralized pattern is applied. Referring to FIG. 3, an image formed while light irradiated from a light source 120 passes through a lattice 121 is focused on a measurement object P by a first focusing lens 122, and the image of the measurement object P is focused on an image sensor 127 by a second focusing lens 124, thereby obtaining an image of the measurement object P on which a pattern of the lattice 121 is projected. In this regard, to form a three-dimensional profile, the lattice 121 is horizontally moved or the first or second focusing lens 122 or 124 is moved to obtain a projected lattice image having a variety of phases. In addition, the lattice 121 is configured to be replaced by a lattice having a period different from that of the lattice 121.

In such measurement apparatus, the image of the lattice 121 is focused on the measurement object P by the first focusing lens 122, the image focused on the measurement object P is measured using the image sensor 127, a Moire pattern is produced from this image and a standard lattice produced from a computer, and thus a three-dimensional profile of the measurement object P can be measured.

However, due to the horizontal movement of the lattice 121, the first focusing lens 122 should be moved to correspond the movement of the lattice 121 in order to form the image of the lattice 121 on the measurement object P through the first focusing lens 122 after the movement of the lattice 121.

In addition, the lattice image focused on the measurement object P is obtained in the image sensor 127 in a subsequent process. In this regard, to accurately focus the lattice image on the image sensor 127, an optical travel distance between the lattice 121 and the measurement object P should correspond to an optical travel distance between the lattice image focused on the measurement object P and the image sensor 127. However, due to the horizontal movement of the lattice 121 and accordingly, the movement of the first or the second focusing lens 122 or 124, it is difficult to accurately adjust the optical travel distances.

### DISCLOSURE OF INVENTION

### Technical Problem

The present invention provides an apparatus for measuring a three-dimensional profile using a LCD, which can form a sine wave pattern having a variety of phases and periods on a measurement object without movement and replacement of a lattice.

The present invention also provides an apparatus for measuring a three-dimensional profile using a LCD, which can form a sine wave pattern having a variety of phases on a measurement object without movement of a focusing lens.

The present invention also provides an apparatus for measuring a three-dimensional profile, which includes a lens system in order to more easily transfer a sine wave pattern to a measurement object, and more easily obtain a focused image,

### TECHNICAL SOLUTION

According to an aspect of the present invention, there is provided an apparatus for measuring a three-dimensional profile using a LCD in which a sine wave pattern is formed on a measurement object, whereby image information of the measurement object is obtained using the sine wave pattern and a camera, and the image information is analyzed to measure a profile of the measurement object, the apparatus comprising a LCD projector comprising: a light source irradiating light forward; a LCD panel disposed at a front side of the light source, generating a sine wave pattern having a plurality of phases and a plurality of periods; polarization plates respectively disposed on front and rear sides of the LCD panel; a first focusing lens disposed apart from a front side of the LCD panel, focusing the sine wave pattern generated by the LCD panel on the measurement object; and a housing supporting the light source, the LCD panel, the polarization plates and the first focusing lens.

The housing may comprise a groove in an inner side thereof, to which the first focusing lens is inserted, and the first focusing lens inserted in the groove is disposed apart from the LCD panel at a constant distance.

For manufacturing advantages, the housing may comprise a housing for a light source in which a light source is installed, a housing for a LCD in which a liquid LCD panel is installed, and a housing for a lens in which the first focusing lens is installed.

The LCD panel may be combined with a rear surface of the housing for a LCD,

An optical travel distance from the LCD projector to the measurement object may be substantially the same as an optical travel distance from the measurement object to the camera. Thus, the image information of the measurement object can be obtained accurately using a camera.

The apparatus may further comprise a lens system that transfers the sine wave pattern generated by the LCD panel to the measurement object, and transfers image information of the measurement object by the sine wave pattern to the camera.

The lens system may comprise a stereo-type lens system having two barrels.

The lens system may comprise a zoom lens to be adjusted to a variety of magnification levels.

### ADVANTAGEOUS EFFECTS

An apparatus for measuring a three-dimensional profile using a LCD, according to the present invention can form a sine wave pattern having a variety of phases and periods on a measurement object without movement of a lattice.

In addition, a sine wave pattern having a variety of phases can be formed on the measurement object without movement of a focusing lens.

In addition, the apparatus of the present invention includes a lens system, and thus the sine wave pattern can be more easily transferred to the measurement object, and a focused image can be more easily obtained.

In addition, through projection of a sine wave pattern having a variety of periods on the measurement object, broad ranges of heights of the measurement object can be measured.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional shadow-type measurement apparatus;

FIG. 2 is a schematic view of a conventional projection-type measurement apparatus;

FIG. 3 is a schematic view of a conventional projection-type measurement apparatus to which a method of projecting a structuralized pattern is applied;

FIG. 4 is a schematic diagram illustrating an apparatus for measuring a three-dimensional profile using a LCD, according to an embodiment of the present invention;

FIG. 5 is an exploded perspective view of a housing of an LCD projector of the apparatus of FIG. 4, according to an embodiment of the present invention;

FIG, 6 is a sectional exploded view of the LCD projector of FIG. 5 taken along a line A-A′ of FIG. 5;

FIG. 7 is a sectional exploded view of the LCD projector of FIG. 5 taken along a line B-B′ of FIGS. 5; and

FIG. 8 is a sectional view of the LCD projector of FIG. 5 when assembled, according to an embodiment of the present invention.

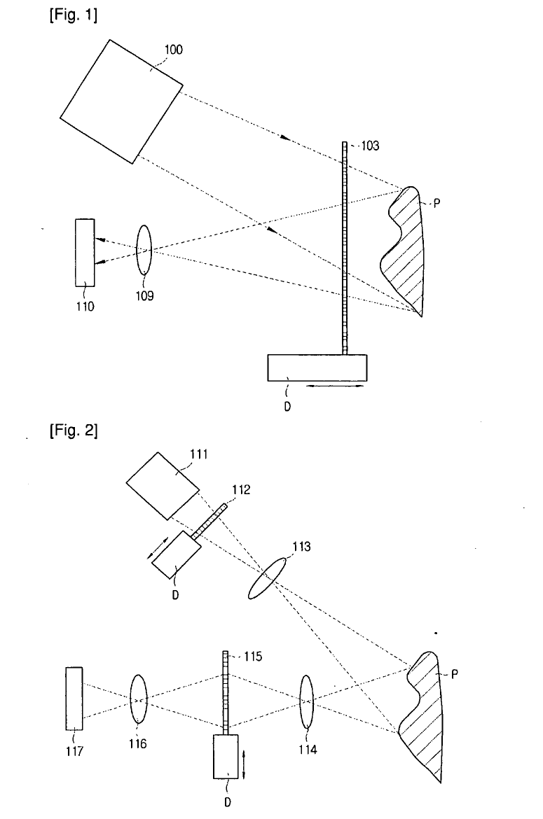

### BEST MODE FOR CARRYING OUT THE INVENTION

An apparatus for measuring a three-dimensional profile using a LCD according to the present invention will now be described more fully with reference to the accompanying drawings, in which exemplary embodiments of the invention are shown.

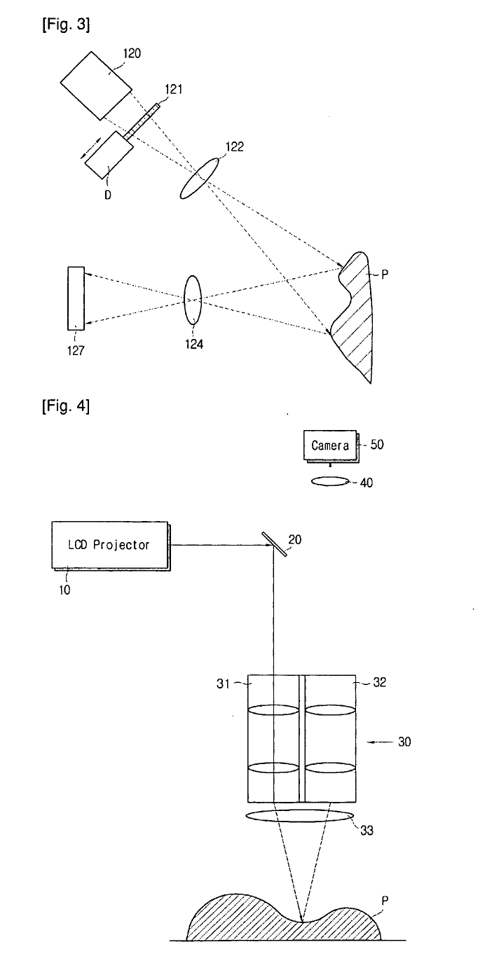

FIG. 4 is a schematic diagram illustrating an apparatus for measuring a three-dimensional profile using a LCD, according to an embodiment of the present invention. Referring to FIG. 4, the apparatus for measuring a three-dimensional profile using a LCD according to the present embodiment includes a LCD projector 10, a total internal reflection mirror 20, a lens system 30, a second focusing lens 40, and a camera 50.

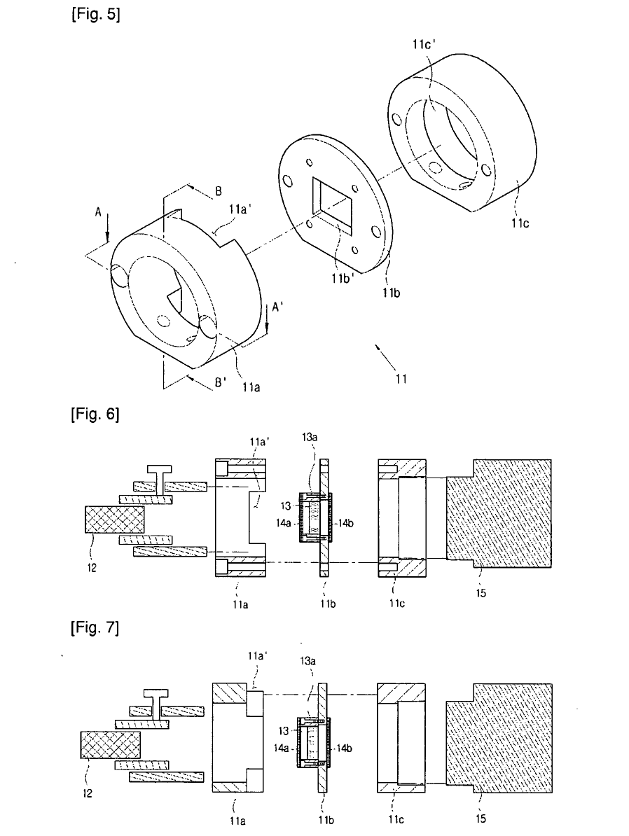

First, the LCD projector 10 will be described. FIG. 5 is an exploded perspective view of a housing 11 of the LCD projector 10 of the apparatus of FIG. 4, according to an embodiment of the present invention. Referring to FIG. 5, the housing 11 of the LCD projector 10 is cylindrically-shaped, includes three parts comprising a housing for a light source 11a in which a light source is installed, a housing for a LCD 11b in which a liquid crystal display (LCD) panel is installed, and a housing for a lens 11c in which a first focusing lens is installed. The three housings can be combined with each other by using screws, or the like.

The housing for a light source 11a is formed as a pipe in the form of a hollow so that light of the light source can be irradiated on a side of a first focusing lens 15, which will be described later, and includes a perforated groove 11a′ that is partially taken to combine with the LCD panel of the housing for a LCD 11b, which will be described later.

The housing for a LCD 11b is combined to the housing for a light source 11a, and includes a hole 11b′ at a center portion thereof so that light of the light source can be irradiated forward via the LCD panel 13 (Refer to FIG. 6).

The housing for a lens 11c is combined with the housing for a LCD 11b, and includes a groove for a lens 11c′ at an inner side of a front side of the housing for a lens 11c, wherein the first focusing lens 15 (Refer to FIG. 6) is inserted in the groove for a lens 11c′, which will be described later.

As described above, the housing 11 of the LCD projector 10 has the three parts combined with each other, and thus the light source, the LCD panel and the first focusing lens, which will be described later, can easily be installed respectively in the three parts.

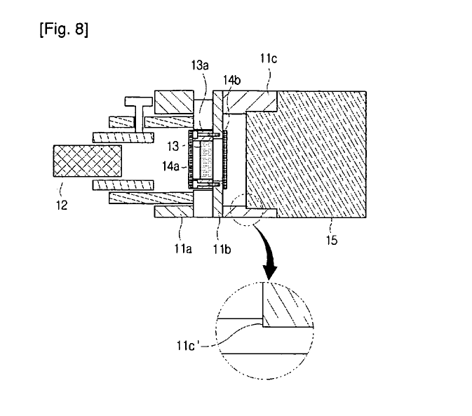

FIG. 6 is a cross-sectional exploded view illustrating the combination of a light source 12, a LCD panel 13, and a first focusing lens 15 in the housing 11 of FIG. 5 taken along a line A-A′ of FIG. 5. FIG. 7 is a sectional exploded view illustrating the combination of the light source 12, the LCD panel 13, and the first focusing lens 15 in the housing 11 of FIG. 5 taken along a line B-B′ of FIG. 5. FIG. 8 is a sectional view of the LCD projector 10 of FIG. 5 when assembled, according to an embodiment of the present invention.

Referring to FIGS. 7 and 8, the light source 12 is installed at a rear side of the housing for a light source 11a so that light can be irradiated forward. in this regard, the light source 12 can be installed in the housing for a light source 11a by using a predetermined combining means.

The LCD panel 13 can be combined with a rear surface of the housing for a LCD 11b by using a combining means 13a and is supported by the combining means 13a. In this regard, the LCD panel 13 can produce a sine wave pattern having a variety of phases and periods by a signal transferred from a control unit.

A pair of rear and front polarization plates 14a and 14b are respectively disposed at rear and front sides of the LCD panel 13. The rear polarization plate 14a polarizes light irradiated from the light source 12 so as to be irradiated forward to the LCD panel 13, and may face the LCD panel 13 and be combined with a rear surface of the combining means 13a.

The front polarization plate 14b polarizes light in a constant direction in order to satisfactorily form a variety of the sine wave patterns produced in the LCD panel 13 on a measurement object. For this, the front polarization plate 14b faces the LCD panel 13 and is disposed on a front surface of the housing for a LCD 11b.

The first focusing lens 15 is inserted in the groove for a lens 11c′ formed in the housing for a lens 11c by using a combining method such as fitting, or the like, and transfers the sine wave pattern produced by the LCD panel 13 forward so as to be formed on a measurement object.

In this regard, the LCD panel 13 produces a sine wave pattern having a variety of phases and periods, and the first focusing lens 15 is fixed to the groove for a lens 11c′ formed in the inner side of the housing for a lens 11e and the LCD panel 13 and the first focusing lens 15 are disposed apart from each other at a constant interval, whereby a lattice pattern can be accurately formed on the measurement object. In addition, a distance between the second focusing lens 40 and the camera 50, which will be described later, is fixed, and thus two optical travel distances can be formed such that an optical travel distance traveled by the sine wave pattern produced by the LCD panel 13 to the measurement object is substantially the same as an optical travel distance between the measurement object and the camera 50. Accordingly, accurate image information of the measurement object can be acquired.

In addition, by projecting a sine wave pattern having a variety of periods produced by the LCD projector 10 on the measurement object, large widths and broad ranges of heights of the measurement object can be measured.

Next, the total internal reflection mirror 20 will be described. Referring to FIG. 4, the total internal reflection mirror 20 is disposed at a front side of the LCD projector 10, and thus can change the path of light irradiated from the LCD projector 10.

By using the total internal reflection mirror 20, it is easy to adjust two optical travel paths such that an optical travel path between the LCD projector 10 and a measurement object P is substantially the same as an optical travel path between the measurement object P and the camera 50 that obtains image information of the measurement object P by the sine wave pattern, and the position of the LCD projector 10 can be freely moved.

The lens system 30 is a stereo-type lens system comprising left-side and right-side barrels 31 and 32 and an object lens 33 disposed at the left- and right-side barrels 31 and 32. The left-side barrel 31 is used as a travel path of light that forms the sine wave pattern produced by the LCD projector 10 on the measurement object P. The right-side barrel 32 is used as a travel path of light in which image information of the measurement object P formed by the sine wave pattern is acquired in the camera 50.

The object lens 33 is disposed to form an image of the sine wave pattern transferred by the left-side barrel 31 on the measurement object P, and is disposed so that image information of the measurement object P, formed on the measurement object P can be transferred to the camera 50 via the right-side barrel 32.

As described above, by using a lens system including two barrels, measurement apparatuses do not need to individually include each element, and thus the manufacturing costs of the apparatuses can be decreased.

In addition, the lens system 30 may be adjusted to a variety of magnification levels by using a zoom lens in each of the left-side barrel 31 and the right-side barrel 32. By using the zoom lens, the sine wave pattern can be enlarged or reduced according to sizes and shapes of the measurement object P, and the image information of the measurement object P obtained by the camera 50 can be enlarged or reduced, and thus a three-dimensional profile of the measurement object P can be measured more accurately.

The second focusing lens 40 is disposed apart from the camera 50 at a constant distance in order that image information of the measurement object P transferred through the lens system 30 can be accurately obtained in the camera 50. Although the camera 50 and the second focusing lens 40 are individually illustrated in FIG. 4, the camera 50 and the second focusing lens 40 may be integrally formed as a single body because a distance between the second focusing lens 40 and the camera 50 should be constant in order to accurately obtain the image information of the measurement object P in the camera 50.

The camera 50, which is a device for obtaining image information of the measurement object P, may be a charge-coupled device (CCD).

The image information of the measurement object P obtained by the camera 50 is transferred to a predetermined control unit and is analyzed by a corresponding program, and thus a three-dimensional profile of the measurement object P may be measured.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

An apparatus for measuring a three-dimensional profile using a LCD, according to the present invention can form a sine wave pattern having a variety of phases and periods on a measurement object without movement of a lattice.

1. An apparatus for measuring a three-dimensional profile using a LCD in which a sine wave pattern is formed on a measurement object, whereby image information of the measurement object is obtained using the sine wave pattern and a camera, and the image information is analyzed to measure a profile of the measurement object,
the apparatus comprising a LCD projector comprising: a light source irradiating light forward; a LCD panel disposed at a front side of the light source, generating a sine wave pattern having a plurality of phases and a plurality of periods; polarization plates respectively disposed on front and rear sides of the LCD panel; a first focusing lens disposed apart from a front side of the LCD panel, focusing the sine wave pattern generated by the LCD panel on the measurement object; and a housing supporting the light source, the LCD panel, the polarization plates and the first focusing lens.

2. The apparatus of claim 1, wherein the housing comprises a groove in an inner side thereof, to which the first focusing lens is inserted, and the first focusing lens inserted in the groove is disposed apart from the LCD panel at a constant distance.

3. The apparatus of claim 2, wherein the housing comprises a housing for a light source in which a light source is installed, a housing for a LCD in which a liquid LCD panel is installed, and a housing for a lens in which the first focusing lens is installed.

4. The apparatus of claim 3, wherein the LCD panel is combined with a rear surface of the housing for a LCD.

5. The apparatus of claim 4, wherein an optical travel distance from the LCD projector to the measurement object is substantially the same as an optical travel distance from the measurement object to the camera.

6-8. (canceled)

9. The apparatus of claim 1, further comprising a lens system that transfers the sine wave pattern generated by the LCD panel to the measurement object, and transfers image information of the measurement object by the sine wave pattern to the camera.

10. The apparatus of claim 5, further comprising a lens system that transfers the sine wave pattern generated by the LCD panel to the measurement object, and transfers image information of the measurement object by the sine wave pattern to the camera.

11. The apparatus of claim 9, wherein the lens system comprises a stereo-type lens system having two barrels.

12. The apparatus of claim 10, wherein the lens system comprises a stereo-type lens system having two barrels.

13. The apparatus of claim 9, wherein the lens system comprises a zoom lens to be adjusted to a variety of magnification levels.

14. The apparatus of claim 10, wherein the lens system comprises a zoom lens to be adjusted to a variety of magnification levels.
